(19) United States
(12) Patent Application Publication
(10) Pub. No.: US 2010/0311258 A1
(43) Pub. Date: Dec. 9, 2010

(54) CONNECTOR ASSEMBLY HAVING IMPROVED COVER

(75) Inventors: PING-SHENG SU, Tu-Cheng (TW); LI-SONG CAO, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/793,712

(22) Filed: Jun. 4, 2010

(30) Foreign Application Priority Data
Jun. 4, 2009 (CN) 200920303975.6

(51) Int. Cl. H01R 13/44

(52) U.S. Cl. 439/136

(57) ABSTRACT

A connector assembly (4) includes a connector (1) and a cover (2). The connector includes a body portion (11) having a mating portion (112), and a shielding shell (10) attached to the body portion and formed with a pair of protrusions (1013). The cover defines a pair of sliding slots (230). The cover covers on said mating portion of the connector in a closed position and is separated from the mating portion along with the protrusions sliding in the sliding slots in an opened position.

### BACKGROUND OF THE INVENTION

1. Field of the Invention

The present invention relates to a connector assembly, and more particularly to a connector assembly having a cover attachable or detachable from a connector conveniently.

2. Description of Related Art

U.S. Patent Application Publication No. 2010/0009561 published on Jan. 14, 2010 discloses a connector assembly comprising an electrical connector, a cover, a cable connected with the electrical connector and a carrier tied on the cable. The cover could be covered on the electrical connector to perform dust-proof function in a closed position. The cover could be separated from the electrical connector to allow the electrical connector to mate with a mating connector in an opened position. When the cover is separated from the electrical connector, the cover is tied to the cable by the carrier to prevent from being lost.

Such a connector assembly has a complicated configuration. Furthermore, it is inconvenient to tie the cover on the cable by the carrier in the opened position and to detach the cover from the carrier in the closed position.

Hence, a connector assembly provided with a cover having a convenient operation is highly desired.

### SUMMARY OF THE INVENTION

Accordingly, an object of the present invention is to provide a connector assembly having a cover convenient to cover on or separate from a connector.

In order to achieve the object set forth, a connector assembly includes a connector and a cover. The connector includes a body portion having a mating portion, and a shielding shell attached to the body portion and formed with a pair of protrusions. The cover defines a pair of sliding slots. The cover covers on said mating portion of the connector in a closed position and is separated from the mating portion along with the protrusions sliding in the sliding slots in an opened position.

When the cover is separated from the connector, the protrusions slide along the sliding slots to permit the cover to move from the closed position to the opened position. It is convenient to enjoy such an operation.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a connector assembly and a cable in accordance with the present invention;

FIG. 2 is a perspective view showing the connector assembly carrying the cable located in an opened position;

FIG. 3 is an exploded perspective view showing the connector assembly carrying the cable in a first option;

FIG. 4 is an exploded perspective view showing the connector assembly carrying the cable in a second option; and

FIG. 5 is an exploded perspective view showing the connector assembly carrying the cable in a third option.

### DETAILED DESCRIPTION OF THE PREFERRED EMBODIMENT

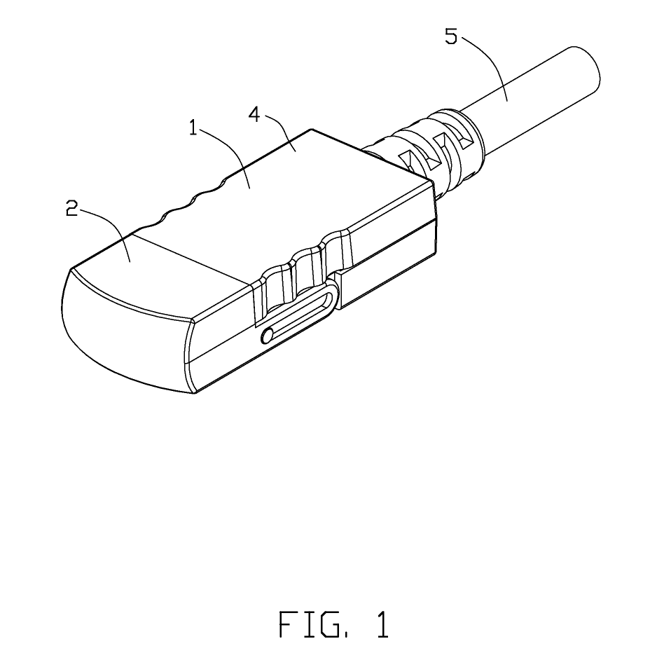

Reference will now be made in detail to the preferred embodiment of the present invention. Referring to FIGS. 1-3, a connector assembly 4 mating with a mating connector (not shown) comprises a connector 1 and a cover 2 covering the connector 1.

The connector 1 comprises a body portion 11 and a shielding shell 10 attached to body portion 11. The body portion 11 has a plurality of contacts 112 mounted therein. The body portion 11 has a mating portion 111 formed at a front end thereof, with the contacts 112 exposed in the mating portion 111. A cable 5 is connected with a rear end of the body portion 11.

The shielding shell 10 comprises a first shell half 101 and a second shell half 100 cooperated with the first shell half 101 to form a receiving cavity 103 therebetween for receiving the body portion 11. The first shell half 101 comprises a front section 1012 and a rear section 1011. The first shell half 101 has a pair of protrusions 1013 each configured as a post and protruding transversely from the front section 1012. The second shell half 100 has a plurality of wave-shaped portions 1002 formed thereon for improving the frictional force.

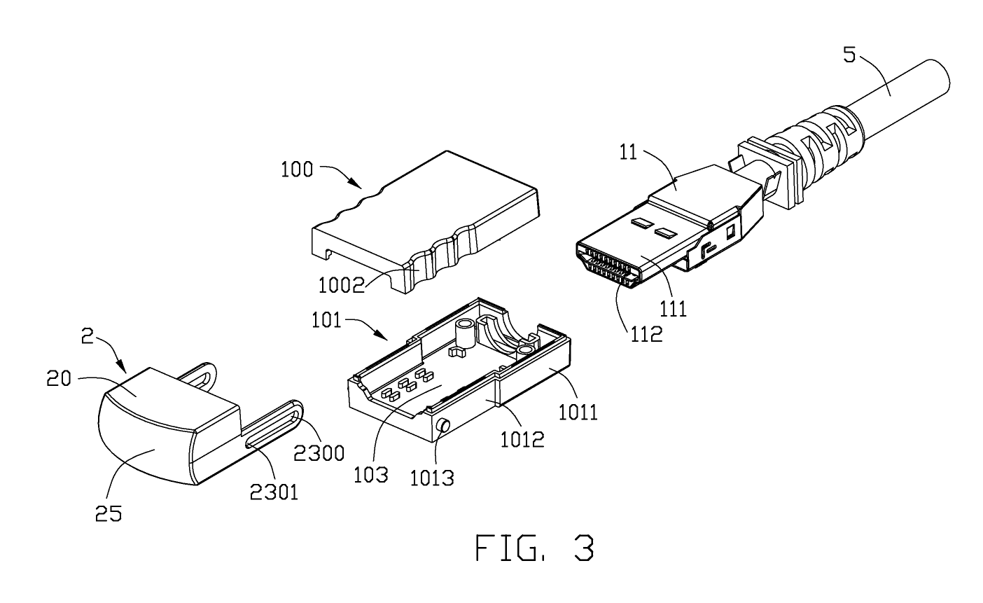

The cover 2 comprises a main body 20 and a pair of cantilevered beams 23. The main body 20 of the cover 2 comprises a cap portion 25, a pair of primary capsulate portions 21 and a pair of side capsulate portions 22 extending from the cap portion 25 and a capsulate cavity 24 defined therebetween for enclosing the mating portion 111 of the connector 1. The pair of cantilevered beams 23 extend from the pair of side capsulate portions 22 along a direction beyond the main body 20. Each cantilevered beam 23 has a sliding slot 230 defined thereon. Each sliding slot 230 has a first end 2301 adjacent to the main body 20 and a second end 2300 beyond the main body 20. The sliding slot 230 preferred in a first option as shown in FIG. 3 extends through opposite surfaces of the cantilevered beam 23.

The front section 1012 has a width smaller than a distance between the pair of cantilevered beams 23. The rear section 1011 has a width substantially identical to the distance between the pair of cantilevered beams 23. The protrusion 1013 has a diameter smaller than or identical to a width of the sliding slot 230.

Referring to FIGS. 1-3, in assembly of the connector assembly 4, the body portion 11 of the connector 1 is partially received in the receiving cavity 103 of the shielding shell 10, with the mating portion 111 exposed outward of the shielding shell 10. The cover 2 is attached to the connector 1, with the protrusions 1013 sliding in the sliding slots 230. The protrusion 1013 would be designed to project outward of the sliding slot 230 a certain distance to prevent itself from dropping off the sliding slot 230.

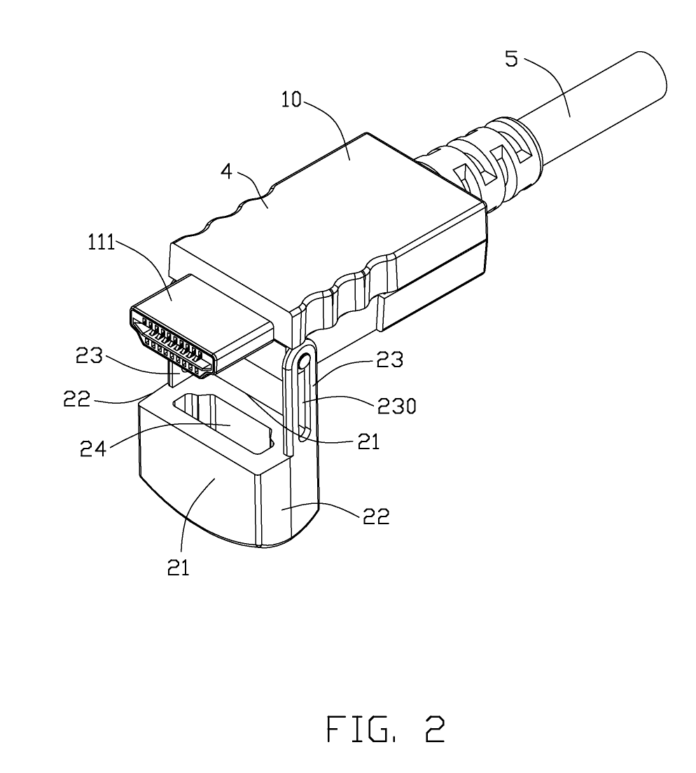

When the cover 2 covers on the mating portion 111 of the connector 1 in a closed position as shown in FIG. 1, each protrusion 1013 is located at the first end 2301. When the cover 2 is separated from the mating portion 111 in an opened position as shown in FIG. 2, each protrusion 1013 slides along the sliding slot 230 from the first end 2301 to the second end 2300.

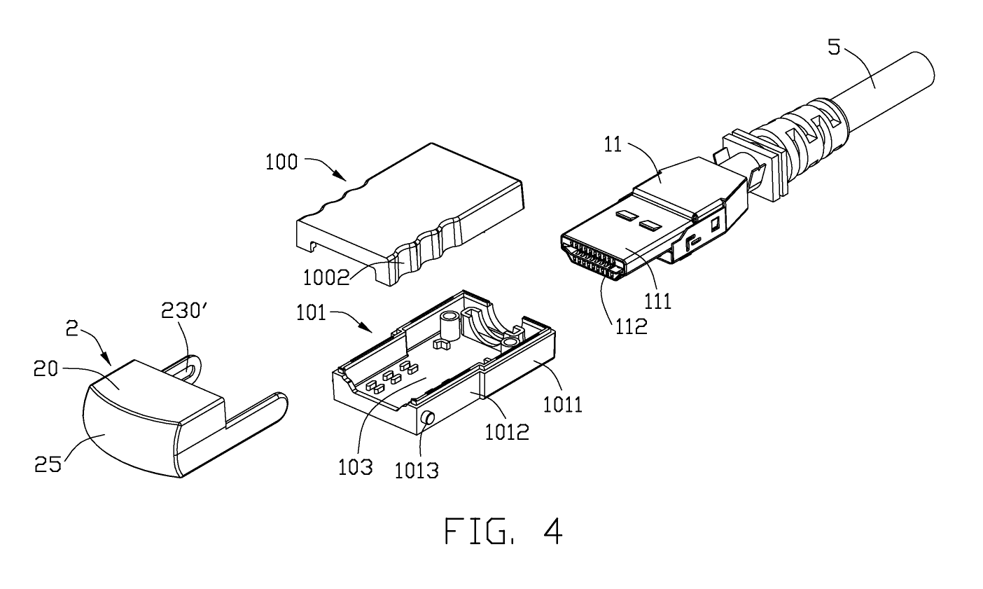

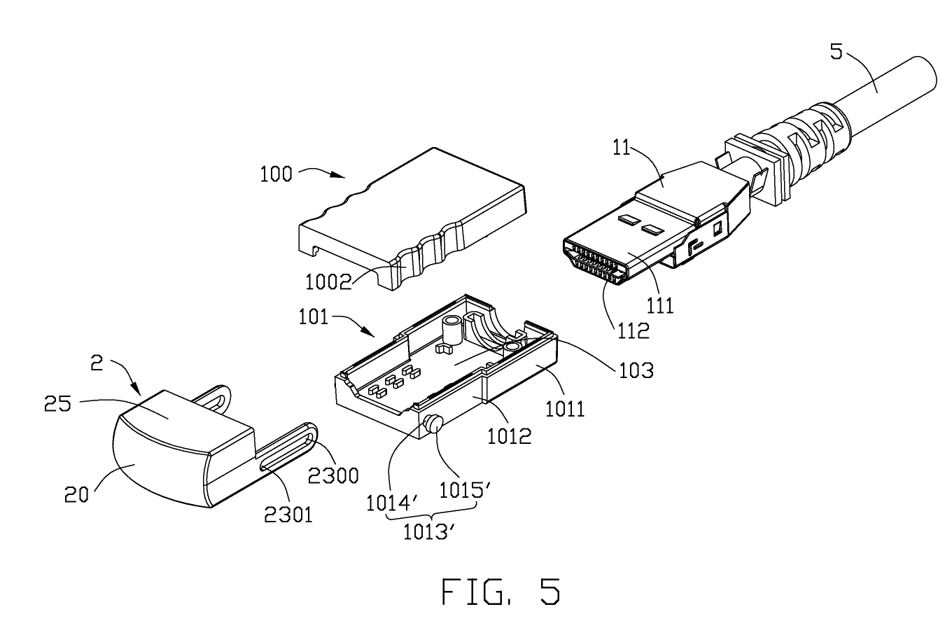

Referring to FIG. 4, in a second option, the sliding slot 230′ could be designed to be recessed from an inner surface of the cantilevered beam 23 and does not reach an outer surface of the cantilevered beam 23. Referring to FIG. 5, in a third option, the protrusion 1013′ comprises a first section 1014′ having a diameter smaller than a width of the sliding slot 230, and a second section 1015′ formed at an outer side of the first section and having another diameter greater than the width of the sliding slot 230. The first section 1014′ of the protrusion 1013 slides in the sliding slot 230 and the second section 1015′ is located at the outside of the sliding slot 230. It is noted that in the embodiments only the first shell half is used to work with the cover 2 so the rotation occurs about a pivot which is not located at the centerline of the shielding shell 10 but with an offset set from the centerline. Such arrangement is one notable feature of the embodiments.

Understandably, in these embodiments, the front section 1012 of the first shell half 101 defines a recessed groove for receiving the corresponding cantilevered beam 23 so that via engagement of the protrusion 1013 within the sliding slot 230, the cantilevered beam 23 itself may be properly retained in such a recessed groove in addition to coupling between the main body 22 of the cover 2 and the mating portion 111 for retaining the cover 2 in position with regard to the shielding shell 10. Under this condition, the pair of primary capsulate portions 21 may be removed from the main body 20 of the cover but only leaving the cap 25 for sealing the opening of the front mating portion 111 so as to have the cover 2 more delicate for meeting a tiny circumstance.

Other alternate approaches may also be further implemented. For example, via a reverse design with regard to the previous embodiments, the cover 2 may be equipped with the protrusions and the first shell half 101 may be equipped with the sliding slot. By following such a reverse design, either the sidewalls of the first shell half 101 or the cantilevered beams 23 are modified in either the lengthwise direction or the lateral direction, to allow the main body 20 the cover 2 may be rested, during exposing the front mating portion 111 for mating, behind the shielding shell 10. As noted, to implement this practice, the cover 2 is initially moved from the inner position to the outer position away from the shielding shell 10 for unrestraint, successively rotated to fully expose the front mating portion 111, and finally moved from the outer position back to the inner position while having the main body 20 of the cover 2 rested upon a joint position between the shielding shell 10 and the cable 5. Under this condition, the cover 2 is essentially rotated about 180 degrees instead of 90 degrees shown in FIG. 2. This alternate arrangement of avoiding obstruction due to the cover during mating is fit for a situation of multiple cable connectors used in the crowded tiny space.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector assembly comprising:
a connector comprising a body portion having a mating portion, and a shielding shell attached to the body portion; and
a cover covering said mating portion of the connector in a closed position and separated from said mating portion in an opened position with at least one protrusion, which is formed in one of the shielding shell and the cover, residing in at least one sliding slot formed in the other of the shielding shell and the cover.

2. The connector assembly as claimed in claim 1, wherein the protrusion is formed on the shielding shell and the sliding slot is formed in the cover,

3. The connector assembly as claimed in claim 2, wherein there are two protrusions formed at opposite sides of the shielding shell, and there are two sliding slots defined on the cover.

4. The connector assembly as claimed in claim 3, wherein said cover comprises a main body and a pair of cantilevered beams extending beyond the main body from opposite sides of the main body, and said two sliding slots are defined at the pair of cantilevered beams respectively.

5. The connector assembly as claimed in claim 4, wherein each sliding slot either is recessed from an inner surface or extends through opposite surfaces of the cantilevered beam.

6. The connector assembly as claimed in claim 5, wherein said sliding slot extends through the opposite surfaces of the cantilevered beam, and said protrusion of the shielding shell comprises a protruding post having a diameter smaller not greater than a width of the sliding slot.

7. The connector assembly as claimed in claim 6, wherein said protrusion projects outward a certain distance from sliding slot.

8. The connector assembly as claimed in claim 5, wherein said sliding slot extends through the opposite surfaces of the cantilevered beam, and said protrusion comprises a first section having a diameter smaller than a width of the sliding slot, and a second section formed at an outer side of the first section and having a diameter greater than the width of the sliding slot.

9. The connector assembly as claimed in claim 4, wherein said sliding slot has a first end adjacent to the main body and a second end beyond the main body, said protrusion being positioned at the first end in the closed position and arriving at the second end in the opened position.

10. The connector assembly as claimed in claim 4, wherein said main body of the cover comprises a cap portion, a pair of primary capsulate portions, a pair of side capsulate portions extending from the cap portion and a capsulate cavity defined therebetween for enclosing said mating portion of the connector, said pair of cantilevered beams extending from said pair of side capsulate portions.

11. The connector assembly as claimed in claim 3, wherein said shielding shell comprises a first shell half and a second shell half cooperating with each other to form a receiving cavity therebetween for partially receiving said body portion, said mating portion being exposed outwardly of said receiving cavity.

12. The connector assembly as claimed in claim 11, wherein said first shell half comprises a front section having a width smaller than a distance between the pair of cantilevered beams, and a rear section having a width substantially identical to the distance between the pair of cantilevered beams, said two protrusions being formed at the front section.

13. An electrical cable connector comprising:
a shielding shell enclosing a body portion with a front mating portion of the body portion forwardly extending out of the shielding shell and with a cable extending out of the shielding shell at a different position;
a plurality of contacts disposed in the body portion with contacting sections disposed in the front mating portion;
a cover defining a main body and at least one beam extending therefrom wherein said main body is configured and dimensioned to cover the front mating portion; and
complementary interengaging devices formed on both said beam and said shielding shell to combine said cover and the said shielding shell together under condition that said cover is moveable relative to the shielding shell between an inner position where the cover is essentially protectively assembled to the shielding shell with the main body covering at least a front opening of the front mating portion in a front-to-back direction, and an outer position where the cover is essentially released from the shielding shell with the main body not only released from the front mating portion but also rotated to fully expose the front mating portion for allowing a complementary connector to be properly coupled to the front mating portion.

14. The electrical cable connector as claimed in claim 13, wherein the cover is moved along said front-to-back direction between the outer position and the inner position.

15. The electrical cable connector as claimed in claim 13, wherein the complementary interengaging devices include a protrusion and a sliding slot.

16. The electrical cable connector as claimed in claim 15, wherein said protrusion is formed on the shielding shell and the sliding slot is formed in the corresponding beam.

17. The electrical cable connector as claimed in claim 13, wherein said complementary interengaging devices are located offset from a centerline of a thickness of the shielding shell and on one side thereof.

18. The electrical cable connector as claimed in claim 17, wherein a gripping area is formed on the other side of the shielding shell opposite to the complementary interengaging devices in a thickness direction.

19. The electrical cable connector as claimed in claim 13, wherein said cover is not able to rotate at the inner position but only covering the front mating portion.

20. An electrical cable connector comprising:
a shielding shell enclosing a body portion with a front mating portion of the body portion forwardly extending out of the shielding shell and with a cable extending out of the shielding shell at a different position;
a plurality of contacts disposed in the body portion with contacting sections disposed in the front mating portion;
a cover defining a main body configured and dimensioned to cover and surround the front mating portion; and
complementary interengaging devices formed on both said cover and said shielding shell to associate said cover with the said shielding shell under condition that said cover is moveable relative to the shielding shell between an inner position where the cover is essentially protectively assembled to the shielding shell with the main body covering the front mating portion in a front-to-back direction and surrounding the front mating portion circumferentially, and an outer position where the cover is essentially released from the shielding shell with the main body not only released from the front mating portion but also rotated to fully expose the front mating portion for allowing a complementary connector to be properly coupled to the front mating portion; wherein
the shielding shell is essentially composed of two halves in a thickness direction, and the interengaging device is formed on essentially only one of the two halves.
